(19) United States
(12) Patent Application Publication
(10) Pub. No.: US 2025/0027583 A1
(43) Pub. Date: Jan. 23, 2025

(54) THIN-WALLED PIPE, METALLIC FLAT MATERIAL AND METHOD FOR PRODUCING A THIN-WALLED PIPE

(71) Applicant: SCHERDEL INNOTEC Forschungs- und Entwicklungs-GmbH, Marktredwitz (DE)

(72) Inventor: Egbert VOGEL, Marktredwitz (DE)

(21) Appl. No.: 18/709,116

(22) PCT Filed: Nov. 11, 2022
(86) PCT No.: PCT/EP2022/081595

§ 371 Date: May 10, 2024

(30) Foreign Application Priority Data
Nov. 17, 2021 (DE) 10 2021 130 027.4

(51) Int. Cl. F16L 9/17; B21D 39/03

(52) U.S. Cl. CPC F16L 9/17; B21D 39/037

(57) ABSTRACT

A thin-walled pipe according to the invention comprises the following features: a thin metallic flat material (22) rolled or bent into a pipe and having a wall thickness of 0.05-1.00 mm, the longitudinal edges (24, 26) of which are connected to each other by connecting elements engaging in one another in form-fitting manner along a connecting portion (6) extending in the pipe longitudinal direction (8); wherein the connecting elements are protrusions (28) on the first longitudinal edge (24) of the flat material (22) and corresponding recesses (12) on the second longitudinal edge (26) of the flat material (22); wherein at least one protrusion (10) engages in a corresponding recess (12) such that the flanks of the protrusion (10) abut, at least partially, in the longitudinal direction of the pipe against the respective adjacent flanks of the corresponding recess (12); wherein at least one pair (32, 34) made up of a protrusion flank and of an abutting recess flank, as seen in an axial sectional plane (A-A) extending along the connecting portion (6), in each case has an inclined course from the pipe outer wall to the pipe inner wall; and wherein at least one pair (32, 34) of a protrusion flank and of an abutting recess flank, as seen in an axial sectional plane (A-A) extending along the connecting portion (6), in each case encloses an angle of 15-75°, in particular 30-60°, with the pipe radial plane.

The present invention relates to a thin-walled pipe, a metallic flat material for producing a thin-walled pipe, and a method for producing a thin-walled pipe.

DE 103 21 863 A1 discloses a pipe, a method for producing a pipe and a use of a pipe. The pipe shown there is made from a substantially planar metallic sheet. The longitudinal edges of the sheet are connected to one another by elements interengaging in positive or form-fitting manner.

In practice it has been shown that such a pipe tends to have its interengaging elements come loose and therefore the pipe as a whole is not dimensionally stable. This disadvantageous effect is particularly pronounced with thin-walled pipes.

Even a slight loosening of the elements results in relatively large gaps, so that the dimensional stability of the pipe is no longer given.

It is therefore an object of the present invention to provide a thin-walled pipe that is permanently dimensionally stable and permanently ensures the function of the pipe, while at the same time being inexpensive to manufacture.

Furthermore, a metallic flat material and a manufacturing process are to be specified, with which a thin-walled pipe can be manufactured at low cost, which is permanently dimensionally stable and ensures its function reliably and permanently.

These objects are fully met by the subject matter of the independent claims. Advantageous further developments are indicated in the dependent claims.

A thin-walled pipe according to the invention comprises the features of claim 1.

According to a basic idea of the invention, loosening of a protrusion on a first longitudinal edge of the flat material relative to a corresponding recess on the second longitudinal edge of the flat material is reliably avoided by at least one pair made up of a protrusion flank and a recess flank abutting thereon each having an inclined course from the pipe outer wall to the pipe inner wall, as seen in an axial sectional plane extending along the connecting portion.

The connection between the protrusions and corresponding recesses is not achieved by overlapping two or more layers-as would also be conceivable-but by positive or form-fitting interengagement, with at least one pair of protrusion flank and abutting recess flank having an inclined course from the pipe outer wall to the pipe inner wall.

The connection according to the invention is based purely on a positive fit by means of geometrically matched connecting elements in conjunction with an inclined or oblique arrangement of at least one pair of a protrusion flank and a recess flank abutting thereon.

The protrusion is thus secured against slipping out of the recess in a radially outward direction and in particular in the direction of unfolding of the thin metallic flat material that is rolled or bent into the pipe, in particular if the pair of protrusion flank and recess flank so to speak forms an inward opening angle and an outward closing angle.

According to a finding underlying the invention, release of the connecting elements, e.g. the protrusions in DE 103 21 863 A1, takes place in a radially outward unfolding direction. Loosening in the unfolding direction of the metallic flat material or in radial direction is reliably prevented by the design of the at least one pair of protrusion flank and abutting recess flank according to the invention, as described above.

According to a further basic idea of the invention, it is possible to form the pipe with a very low wall thickness (n), i.e. very thin-walled, by forming at least one pair of protrusion flank and abutting recess flank as described above. The wall thickness of the thin metallic flat material rolled or bent into a pipe is 0.05-1.00 mm.

The inventor of the present subject matter of the application has found that the conventional manufacturing processes for pipes, as described for example in DE 103 21 863 A1, have a natural lower limit to the material thickness. Thus, if pipes with too low wall thickness are produced in the manner described there, there is no stable connection achieved and the pipe produced in this way is not dimensionally stable. This is improved according to the invention. A pipe according to the invention is very dimensionally stable.

A pipe according to the invention also provides for sufficient tightness for fluids with greater viscosity, for example for viscous oils or for fine-grained solids, for example sand.

The direction and inclination of the at least one pair of protrusion flank and abutting recess flank ensure high durability and dimensional stability of the connection and thus of the pipe as a whole.

A thin-walled pipe is understood here to be a thin metallic flat material rolled or bent into a pipe, regardless of its shape in cross-section, so that in addition to round cross-sections, oval cross-sections, elliptical cross-sections, multi-arc cross-sections or angular cross-sections, e.g. square, pentagonal, hexagonal or polygonal pipe cross-sections are also comprised by the invention.

Pipes of short length, e.g. sleeves, are also comprised by the invention.

The connecting portion with the at least one pair of protrusion flank and abutting recess flank, which are formed according to the invention, can also be referred to as an end-face connection or as an end-face connecting portion.

According to a further basic idea of the present invention, the connecting portion with the at least one pair of protrusion flank and abutting recess flank formed according to the invention is formed without a material connection, i.e. without an additional material connection, which could be created e.g. by welding or soldering. This reduces manufacturing costs. Nevertheless, the flat material is reliably and permanently connected along its connecting portion, and the pipe is thus permanently dimensionally stable and permanently reliably secured against loosening of the connecting elements.

Thin-walled pipes according to the invention can be used in a variety of ways. They can be used, for example, in medical technology for insulin cylinders or in electrical engineering for small electric motors or pole housings of small electric motors.

The thin-walled pipe according to the invention realizes a self-forming positive pressure-joint connection.

According to the invention, at least one pair of a protrusion flank and an abutting recess flank in each case encloses an angle of 15-75°, in particular 30-60°, with the pipe radial plane, as seen in an axial sectional plane extending along the connecting portion.

The protrusions on the first longitudinal edge each have two lateral protrusion flanks and a front end face or a front end face portion which connects the two protrusion flanks to each other. A rear bottom side or a rear bottom side portion is arranged between two adjacent protrusions.

The recesses on the second longitudinal edge each have two lateral recess flanks and a rear bottom side or a rear bottom side portion, which connects the two lateral recess flanks to each other. A front end face or a front end face portion is arranged between two adjacent recess flanks each.

The lateral protrusion flanks, the front end faces or front end face portions and the rear bottom sides or rear bottom side portions of the protrusions and also the lateral recess flanks, the rear bottom sides or rear bottom side portions and the front end faces or front end face portions of the recesses extend from the first to the second surface of the thin metallic flat material, or from the outer jacket surface to the inner jacket surface of the thin-walled pipe. Their height can substantially correspond to the wall thickness.

The axial sectional plane of the last feature of claim 1 extends through the axis of symmetry of the pipe. This axial sectional plane, which defines the inclined course of the pair of protrusion flank and abutting recess flank, also extends along the connecting portion.

The connecting portion extends in the longitudinal direction of the pipe. Along the connecting portion, the connecting elements engage positively with each other at the longitudinal edges, and thus the longitudinal edges are connected to each other.

This condition is fulfilled for a large number of axial sectional planes as long as they each extend through the axis of symmetry of the pipe and through the connecting portion in which each pair of protrusion flank and abutting recess flank has an inclined course from the pipe outer wall to the pipe inner wall.

According to an embodiment, the pipe has a first axial pipe end and a second axial pipe end.

According to a further embodiment, at least one pair made up of a protrusion flank and an abutting recess flank, as seen in a sectional plane along the connecting portion, in each case has an inclined course with a first oblique direction of extension from the pipe outer wall to the pipe inner wall in the direction of the first pipe end, and at least one pair made up of a protrusion flank and an abutting recess flank, as seen in a sectional plane along the connecting portion, in each case has an inclined course with an opposite second oblique direction of extension from the pipe outer wall to the pipe inner wall in the direction of the second pipe end.

Such a design with at least one pair of protrusion flank and abutting recess flank with a first oblique direction of extension and at least one pair of protrusion flank and abutting recess flank with an opposite second oblique direction of extension results in an opposite inclined or oblique arrangement of these pairs of protrusion flank and abutting recess flank, which results in a self-locking effect that provides a particularly reliable and permanent connection of the respective protrusion to the corresponding recess.

According to a further embodiment, pairs of a protrusion flank and an abutting recess flank with a first oblique direction of extension, as seen along the connecting portion, are arranged alternately with pairs of a protrusion flank and an abutting recess flank with an opposite second oblique direction of extension, so that the protrusions and recesses, as seen in a sectional plane along the connecting portion, in particular alternately have substantially the shape of a parallelogram and substantially the shape of a trapezoid.

Such an arrangement of pairs of protrusion flanks and abutting recess flanks achieves a particularly durable and reliable connection of the connecting elements along the connecting portion and reliable dimensional stability of the thin-walled pipe across the entire connecting portion.

According to a further embodiment, the sequence of the pairs of a protrusion flank and an abutting recess flank, as seen along the connecting portion, is at least partially as follows:
alternately two pairs each with a first oblique direction of extension, and two, four or six pairs each with an opposite second oblique direction of extension; or
alternately four pairs each with a first oblique direction of extension, and two, four or six pairs each with an opposite second oblique direction of extension;
alternately six pairs each with a first oblique direction of extension, and two, four or six pairs each with an opposite second oblique direction of extension.

According to a further embodiment, at least one protrusion engages in a corresponding recess in such a way that the end face of the protrusion abuts at least in portions or partially on the end face of the corresponding recess; and/or the end faces are located substantially in an axial plane extending along the connecting portion.

This embodiment is based on the inventors' finding that for a permanent connection between protrusions and corresponding recesses it is not necessary for an inclined course to be provided between the end face of the protrusion and the end face of the corresponding recess, although this is of course also conceivable or comprised by the present invention. In particular, the end faces of the protrusion and corresponding recess are abutting one another and are arranged substantially in an axial plane extending along the connecting portion, e.g. a radial plane or a plane substantially parallel to the radial plane.

According to a further embodiment, a bead, a material accumulation portion or a material thickening portion is formed in the abutting area of at least one pair of a protrusion flank and an abutting recess flank.

Such a bead, such a material accumulation portion or such a material thickening portion results from the fact that in the metallic flat material from which the thin-walled pipe is rolled or bent, the respective protrusion or protrusions may be formed with an oversize, in particular in width, with respect to the corresponding recess/recesses, as will be explained in more detail below with reference to the metallic flat material and the manufacturing method.

Such a bead, such a material accumulation portion or such a material thickening portion can be avoided or reduced if a corresponding waist or a corresponding material-free portion is provided at the pipe transverse ends of the metallic flat material. When joining the protrusions with oversize, in particular in width, compared to the corresponding recesses, the excess material can occupy the previously material-free area of the waist/the previously material-free area.

According to a further embodiment, at least one protrusion and/or at least one recess has a tapered neck portion and a widened head portion.

According to a further embodiment, at least one protrusion and/or at least one recess has a tapered neck portion and a widened head portion, with an intermediate collar in the neck portion, which subdivides the neck portion into a head-side recess portion and a bottom-side recess portion.

According to a further embodiment, at least one protrusion and/or at least one recess, as seen in plan view, has the shape of a rounded puzzle piece protrusion or a rounded puzzle piece recess, or the shape of a dovetail.

Protrusions and recesses formed in this way can be easily produced and joined together when forming a pipe. At the same time, they provide a particularly reliable and durable connection due to their geometry.

The inclined course from the protrusion flank to the abutting recess flank can be present in the widened head portion only, and in the tapered neck portion there can be a straight, in particular substantially radial course between the neck portion of the protrusion and the neck portion of the recess, or the corresponding plane can lie substantially in the pipe radial plane.

Alternatively, the inclined course from the protrusion flank to the abutting recess flank can be formed both in the head portion and in the neck portion.

The present invention also relates to a metallic flat material for producing a thin-walled pipe by rolling or bending, comprising the features of claim 8.

The wall thickness of the metallic flat material is 0.05-1.00 mm.

The advantages and embodiments stated above with reference to the thin-walled pipe according to the invention apply analogously to the metallic flat material according to the invention.

Due to the fact that the connecting element that is formed as a protrusion is bent with respect to the plane of the main body of the metallic flat material, such a connecting element, when rolling or bending the flat material into a thin-walled pipe, can engage in a corresponding connecting element that is formed as a recess and can be bent into the plane of the main body of the metallic flat material, in particular into the plane of the connecting portion, so that an inclined course from the pipe outer wall to the pipe inner wall is created in at least one, in particular both protrusion flanks of this protrusion and the respective abutting recess flank, or that the pair of protrusion flank and abutting recess flank encloses an angle of 15-75°, in particular 30-60°, with the pipe radial plane.

Thus, a metallic flat material formed in this way can be used to produce a thin-walled pipe according to the invention, in which loosening of the connecting elements from each other, e.g. in the unfolding direction or in the direction radially outwards, is avoided and permanent dimensional stability is ensured.

According to an embodiment, at least one connecting element designed as a recess can also be bent at least in portions with respect to the plane of the main body of the metallic flat material.

According to a further embodiment of the metallic flat material, the protrusion is oversized with respect to the corresponding recess. The size of the oversize can be selected taking into account the type of material, the material thickness and the tensile strength/hardness. The oversize can be selected such that the width of the protrusion is greater than the width of the corresponding recess, e.g. by an oversize of 0.05-1.0 mm. The length of the protrusion can substantially correspond to the length of the recess.

The oversize fit of the protrusion in relation to the corresponding recess, in particular in the width direction, enhances the formation of an inclined course from the protrusion flank to the respective abutting recess flank.

There is thus created a form-fit, but not a material-fit connection between protrusion and corresponding recess, with an inclined lateral flank course.

As already explained above, due to the oversize fit in the transverse direction, the excess material can form a bead, a material accumulation portion or a material thickening portion in the area of the protrusion flank and the abutting recess flank.

In the metallic flat material according to the invention, the protrusion has a straight course when viewed from the front of the first longitudinal edge and forms an angle with the plane of the main body of the metallic flat material.

According to a further embodiment, at least one protrusion with a first direction of extension and at least one protrusion with a second direction of extension are provided.

The protrusion with the first direction of extension may have a relative slope or gradient from the first end of the flat material to the second end of the flat material, as seen in a front view of the first longitudinal edge. The protrusion with the second direction of extension may have a relative gradient from the second end of the flat material to the first end of the flat material, as seen in a front view of the first longitudinal edge.

According to a further embodiment, the sequence of the protrusions with a first direction of extension and of the protrusions with a second direction of extension, as seen along the longitudinal edge, is at least in portions as follows:
alternately one protrusion each with first direction of extension and one to five protrusions each with second direction of extension; or
alternately two protrusions each with first direction of extension and one to five protrusions each with second direction of extension; or
alternately three protrusions each with first direction of extension and one to five protrusions each with second direction of extension.

A protrusion or protrusions formed in this way can be produced easily and inexpensively using the metallic flat material, for example by stamping and then bending the metallic flat material.

When rolling or bending the metallic flat material into a thin-walled pipe, such a protrusion or protrusions can be joined well and automatically and bent into the plane, in particular into the tangential plane of the connecting portion, so that these protrusions engage in corresponding recesses and create a form fit therewith with an oblique direction of extension of abutting protrusion and recess flanks.

According to a further embodiment, the recesses on the second longitudinal edge of the metallic flat material, which are each located in a longitudinal position between two adjacent protrusions, can each have an inverse shape to the protrusions.

According to a further embodiment, at least one protrusion and/or at least one recess may have a tapered neck portion and a widened head portion.

According to a further embodiment, at least one protrusion and/or at least one recess has a tapered neck portion and a widened head portion, with an intermediate collar in the neck portion, which subdivides the neck portion into a head-side recess portion and a bottom-side recess portion.

According to a further embodiment, at least one protrusion and/or at least one recess, as seen in plan view, has the shape of a rounded puzzle piece protrusion or a rounded puzzle piece recess, or the shape of a dovetail.

The sequence of the protrusions with a first direction of extension and with a second direction of extension can be adapted as required.

The advantages already mentioned above with reference to the thin-walled pipe apply to this embodiment as well.

The invention also relates to a method for producing a thin-walled pipe according to claim 13.

By such a method according to the invention, a thin-walled pipe of the type described here can be produced in simple and inexpensive manner, the connecting elements of which are reliably and permanently connected to one another, as has been explained with reference to claim 1, without the necessity of additionally providing a welding connection for this purpose.

The method according to the invention can be automated, so that a large number of dimensionally stable thin-walled pipes according to the invention can be produced.

The advantages and embodiments indicated above with reference to the thin-walled pipe according to the invention and the metallic flat material according to the invention apply equally to the method according to the invention.

To avoid repetitions, these will not be repeated again in procedural analogy. However, the applicant expressly reserves the right to draw up method claims at a later date which correspond to the dependent product claims.

The present invention will be explained in more detail below with reference to the accompanying figures.

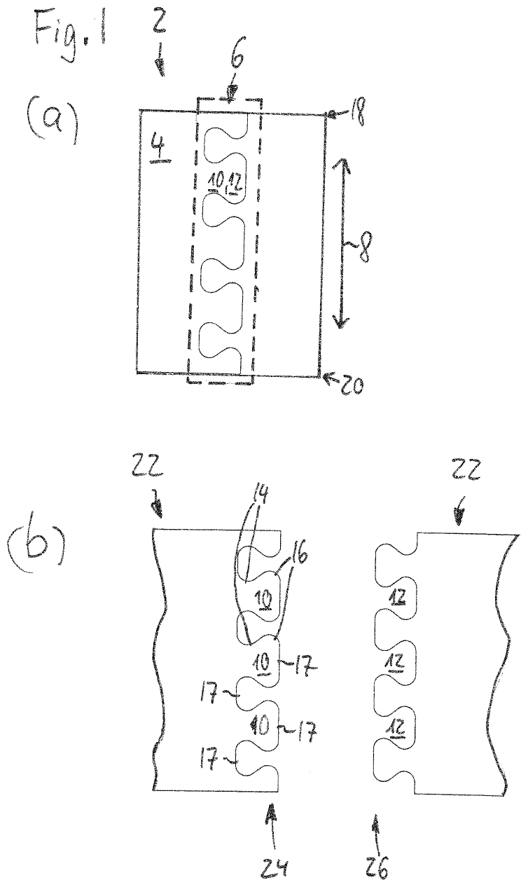

FIG. 1 shows, by way of its partial FIG. 1(a), a side view of a pipe in which protrusions and recesses engage with one another along a connecting portion, and, by way of its partial FIG. 1(b), two metallic flat materials with protrusions on a first longitudinal edge and with recesses on a second longitudinal edge, for producing a pipe according to partial FIG. 1(a), wherein the protrusions and recesses are each formed in the shape of puzzle pieces.

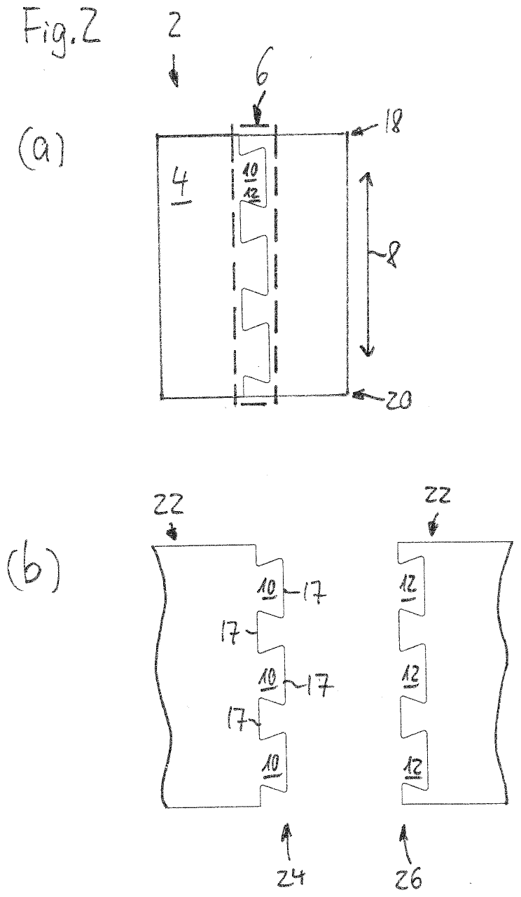

FIG. 2 shows, by way of its partial FIG. 2(a), a side view of a pipe in which protrusions and recesses engage with one another along a connecting portion, and, by way of its partial FIG. 2(b), two metallic flat materials with protrusions on a first longitudinal edge and with recesses on a second longitudinal edge, for producing a pipe according to partial FIG. 2(a), wherein the protrusions and recesses are each formed in the shape of dovetails.

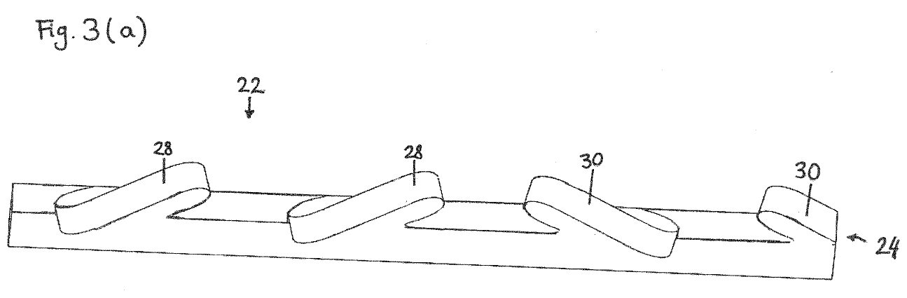

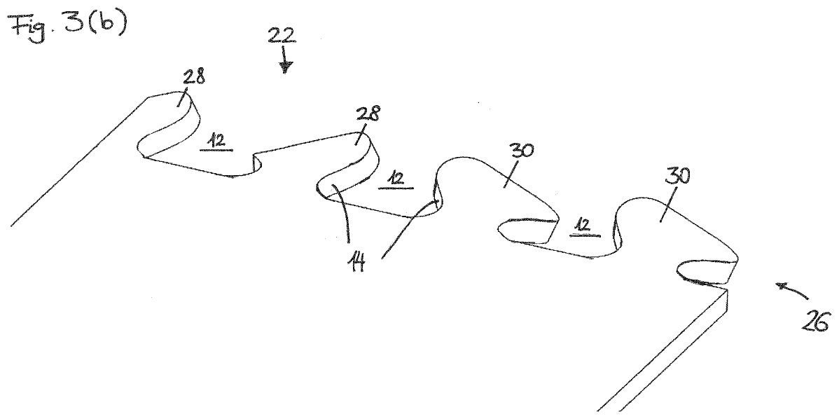

FIG. 3 shows, by way of its partial FIG. 3(a), a perspective view of the first longitudinal edge of the metallic flat material of FIG. 1(b), wherein the protrusions, as seen in a front view of the longitudinal edge, each have a straight course which encloses an angle with the plane of the main body of the metallic flat material, and wherein protrusions with a first direction of extension and protrusions with a second direction of extension are provided; and by way of its partial FIG. 3(b) a perspective view of a second longitudinal edge of the metallic flat material of FIG. 1(b), wherein the protrusions, as seen in a front view of the longitudinal edge, each have a straight course which encloses an angle with the plane of the main body of the metallic flat material, and wherein protrusions with a first direction of extension and protrusions with a second direction of extension are provided.

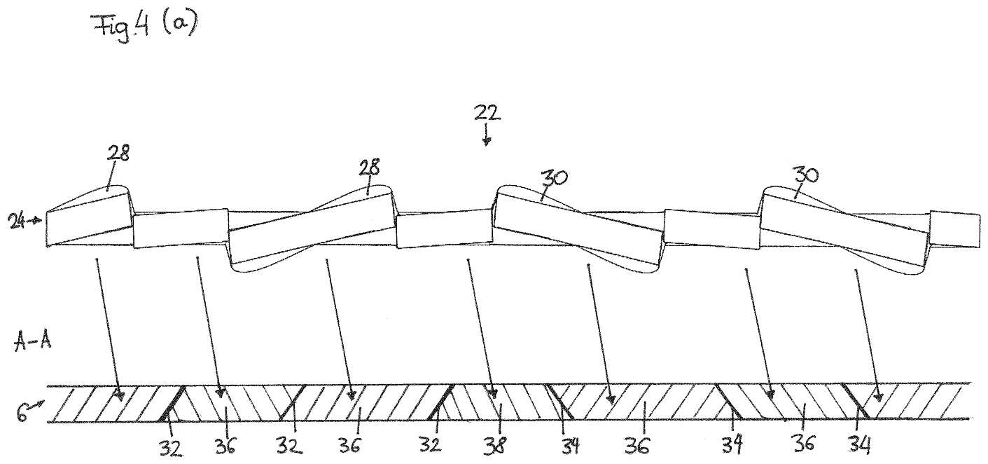

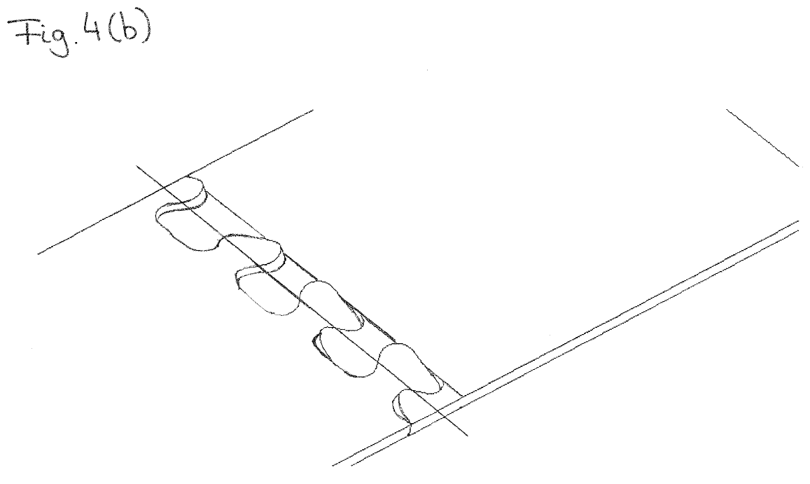

FIG. 4 shows by way of its partial FIG. 4(a) a schematic diagram of a first longitudinal edge of the metallic flat material of FIG. 1(b) and FIG. 3(a) and the shape and arrangement of the protrusions and the recesses as well as the protrusion flanks and the recess flanks in a sectional plane along the connecting portion, after the protrusions and recesses have been joined together and formed into a closed connecting portion of the pipe as shown in FIG. 1(a); and by way of its partial FIG. 4(b), the state in which the protrusions and recesses of the two longitudinal edges have been joined together to form a closed connecting portion, but before the method step of forming the protrusions into the plane, in particular into the tangential plane of the connecting portion.

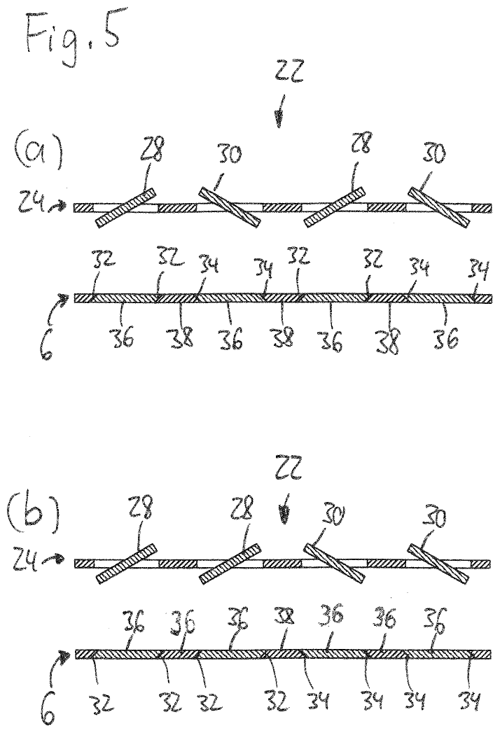

FIG. 5 shows a schematic diagram with a front view of a first longitudinal edge of a metallic flat material and a sectional view along an axial sectional plane extending along the connecting portion after the protrusions and recesses have been joined together and formed into a closed connecting portion of a thin-walled pipe, with a first alternating sequence of the directions of extension of the protrusions (partial FIG. 5(a)); and with a second alternating direction of extension of the protrusions in pairs (partial FIG. 5(b)).

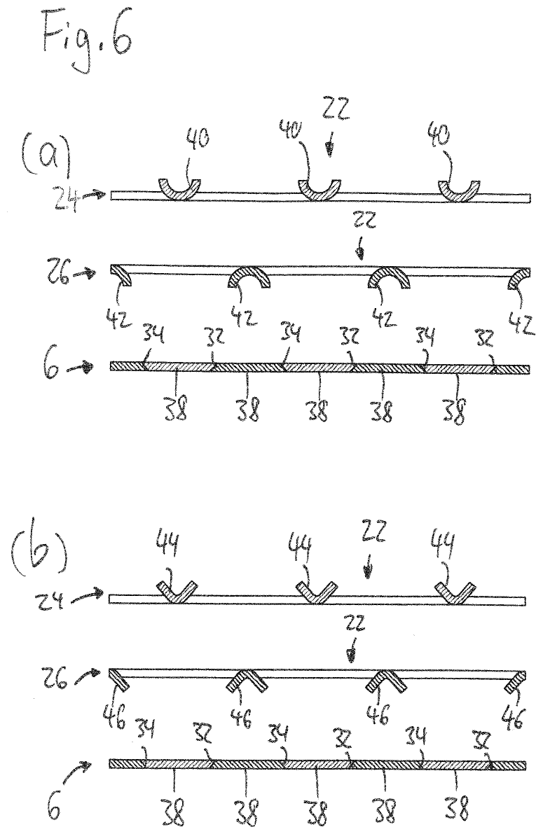

FIG. 6(a) shows a schematic diagram with an upper front view of a first longitudinal edge of a metallic flat material with protrusions each formed in a U-shape, below this a second front view of a second longitudinal edge of a metallic flat material with protrusions in the shape of an inverted U, and below this a sectional view along an axial sectional plane extending along the connecting portion of the pipe, after the protrusions and recesses have been joined together and formed into a pipe, and

FIG. 6(b) shows a schematic diagram with an upper front view of a first longitudinal edge of a metallic flat material with protrusions each formed in a V-shape, below this a second front view of a second longitudinal edge of a metallic flat material with protrusions in the shape of an inverted V, and below this a sectional view along an axial sectional plane extending along the connecting portion of the pipe after the protrusions and recesses have been joined together and formed into a pipe.

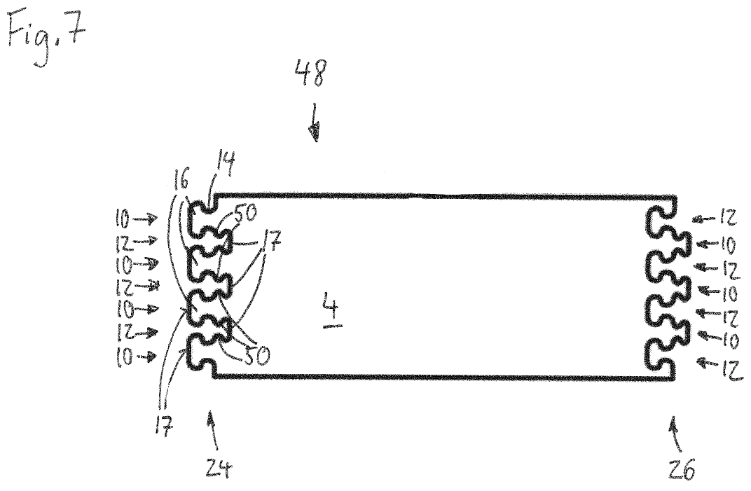

FIG. 7 shows a metallic flat material with a first longitudinal edge and a second longitudinal edge and with protrusions and recesses arranged alternately on both longitudinal edges.

The side view of FIG. 1(a) shows a pipe 2 according to an exemplary embodiment of the present invention, which has been produced from a metallic flat material 22, for example by rolling or bending, such that the metallic flat material 22 forms the jacket 4 of the pipe 2 and the connecting elements 10, 12 are connected to each other at the longitudinal edges 24, 26 by positive interlocking or interengagement along a connecting portion 6 extending in the pipe longitudinal direction 8.

FIG. 1(b) shows the starting material for the pipe 2 shown in FIG. 1(a), namely a metallic flat material 22, which may be a sheet material (also briefly referred to as sheet metal) made of steel, aluminum or stainless steel or a strip made of steel, aluminum or stainless steel, which may in particular be galvanized. Non-ferrous metal alloys such as CuSn or CuZn are also quite suitable. This metallic flat material 22 has a first longitudinal side/longitudinal edge 24 and a second longitudinal side/longitudinal edge 26 opposite the first longitudinal side/longitudinal edge 24.

In FIG. 1(b), two metallic flat materials 22 are shown side by side. In the case of the first metallic flat material 22, shown on the left in FIG. 1(b), only the right longitudinal edge can be seen, which is referred to above as the first longitudinal edge 24. The second longitudinal edge 26 can be imagined on the left opposite the first longitudinal edge 24. In the case of the second metallic flat material 22 arranged on the right in FIG. 1(b), only the left longitudinal edge can be seen, which is referred to here as the second longitudinal edge 26. The first longitudinal edge can be imagined on the right opposite the second longitudinal edge 26.

The first longitudinal edge 24 has a pattern of protrusions 10 and recesses 12 therebetween. Similarly, the second longitudinal edge 26 has a pattern of recesses 12 and protrusions 10 formed therebetween. As can be clearly seen in FIG. 1, both the protrusions 10 and the recesses 12 each have a rounded, puzzle-piece-like shape, with a neck portion 14 of smaller width and a head portion 16 of larger width.

Between two opposing neck portions 14 of reduced width of the same recess 12, there is formed a respective a rear end face portion 17.

Similarly, a front end face portion 17 of the protrusion 10 is formed on that side of the protrusion 10 which faces the respective opposite longitudinal edge.

As can be clearly seen in FIG. 1(b), in the longitudinal direction along the first or second longitudinal edge 24, 26, the position of the protrusions 10 on the first longitudinal edge 24 corresponds in each case to the position of the recesses 12 on the second longitudinal edge 26, and likewise the position of the recesses 12 on the first longitudinal edge corresponds in each case to the position of the protrusions 10 on the second longitudinal edge 26. The shape of the protrusions 10 and recesses 12 on the first longitudinal edge 24 also corresponds in each case to the shape of the recesses 12 and the protrusions 10 on the second longitudinal edge 26.

In particular, the depth of the protrusions 10 and the recesses 12 on the first longitudinal edge 24 in each case corresponds to the depth of the recesses 12 and the protrusions 10 on the second longitudinal edge 26, as seen in the left-right direction of the drawing plane in FIG. 1(b).

The width of the protrusions 10 on the first longitudinal edge 24 is in each case formed slightly oversized with respect to the width of the corresponding recesses 12 on the second longitudinal edge 26, in particular with an oversize of 0.05-1.0 mm, as seen in the longitudinal direction of the respective longitudinal edge 24, 26, i.e. in the top-bottom direction of the drawing plane in FIG. 1(b). The same applies to the width of the protrusions 10 on the second longitudinal edge 26, which are also formed with an oversize of in particular 0.05-1.0 mm with respect to the corresponding recesses 12 on the first longitudinal edge 24.

In the manufacture of the thin-walled pipe 2, as shown in FIG. 1(a), from the metallic flat material 22, as shown in FIG. 1(b), the metallic flat material 22 is bent to form a pipe 2, using a mandrel or center piece around which the pipe is in particular rolled or bent, and using a block or counterpart pressing against the same from the outside.

In doing so, the longitudinal edges 24 and 26 are joined together in such a way that the connecting elements, i.e. the protrusions 10 and the recesses 12 along the connecting portion 6 shown in FIG. 1(a), which extends in the longitudinal direction of the pipe, each engage with one another in a form-fitting manner.

The protrusions 10, in particular at least the protrusions 10 on one of the two longitudinal edges 24 and 26, are bent at least in portions with respect to the plane of the main body of the metallic flat material 22, as can be clearly seen in FIGS. 3 to 6.

In joining the longitudinal edges 24 and 26 together, the protrusions 10 are bent into the plane, in particular the tangential plane, of the connecting portion 6 using the mandrel or center piece and the block or counterpart pressing against the same from the outside, in such a way that a pair made up of a protrusion flank of the protrusions 10 and of the respective abutting recess flank of the corresponding recess 12, as seen in an axial sectional plane extending along the connecting portion 6, in each case has an inclined course from the pipe outer wall to the pipe inner wall and/or encloses an angle of 15-75°, in particular 30-60°, with the pipe radial plane. This can be clearly seen with reference to FIGS. 4 to 6.

The pipe 2 shown in FIG. 2(a) and the flat material 22 or flat materials 22 shown in FIG. 2(b) correspond respectively to the pipe 2 shown in FIG. 1(a) and the flat material 22 or flat materials 22 shown in FIG. 1(b), with the protrusions 10 and the recesses 12 each having a different shape, namely the shape of a dovetail.

Identical elements are marked with the same reference numerals and will not be described again to avoid repetitions.

The protrusions 10 each have a protrusion flank with a straight course, which in particular includes an angle with the longitudinal direction of extension of the metallic flat material 22 or the metallic flat materials 22, i.e. with a plane extending in the left-right direction and orthogonally through the drawing plane. This angle can be e.g. 10 to 40°. In the present exemplary embodiment, it is approximately 20°.

The rear side of each of two adjacent protrusion flanks is adjoined by a rear end face portion 17 which extends orthogonally through the drawing plane in the pipe longitudinal direction 8, i.e. in the top-bottom direction in FIG. 2(b), and which connects the two adjacent protrusion flanks to one another. Likewise, each protrusion 10 has a front end face portion 17 formed between the front ends of the protrusion flanks, which also extends in an up-down direction shown in FIG. 2(b) or in the pipe longitudinal direction 8 shown in FIG. 2(a).

Also in FIG. 2, the protrusions 10 on one longitudinal edge 24, 26 are each formed with an oversize of in particular 0.05-1.0 mm in the width direction, i.e. in the top-bottom direction according to FIG. 2(b), with respect to the corresponding recesses 12 on the respective opposite longitudinal edge 26, 24.

The manufacturing process of the thin-walled pipe 2 according to FIG. 2(a) from the metallic flat material 22 or the metallic flat materials 22 of FIG. 2(b) is implemented as described with reference to FIG. 1. This will not be repeated again in order to avoid repetitions.

In FIG. 3(a) and in FIG. 3(b), the protrusions along the first longitudinal edge 24 and the protrusions along the second longitudinal edge 26 are formed as protrusions 28 with a first oblique direction of extension and as protrusions 30 with a second oblique direction of extension.

It can be clearly seen that the head portion of the protrusions 28 and 30, as seen in a front view of the longitudinal edge 24 or 26, has an at least partially straight course and encloses an angle with the plane of the main body of the metallic flat material 22, in particular an angle of 10-30°, in the present embodiment of about 20°.

The neck portion 14, which connects the main body of the metallic flat material to the respective head portion of the protrusion 28, 30, can either still be located substantially in the plane of the main body of the metallic flat material, or it can form a bending transition portion in which a transition takes place from the plane of the main body of the metallic flat material 22 to the bent head portion of the respective protrusion 28, 30.

Again, but less clearly recognizable than in FIG. 1, the protrusions 28, 30 are formed on a longitudinal edge 24, 26 with an oversize each in the width direction relative to the recesses 12 on the respective opposite longitudinal edge 26, 24.

However, when FIGS. 3(a) and 3(b) are viewed together, it is clearly recognizable that, viewed from left to right and thus in the longitudinal direction along the connecting portion 6 or in the pipe longitudinal direction, at positions where a protrusion 28, 30 is arranged on the second longitudinal edge 26, a respective recess 12 is positioned on the first longitudinal edge 24, and at positions where a protrusion 28, 30 is formed on the first longitudinal edge 24, a respective recess 12 is positioned on the second longitudinal edge 26.

FIG. 4(a) shows on top of each other a front view of the first longitudinal edge 24 according to FIG. 3(a) and a sectional view along the sectional plane A-A according to FIG. 4(b), which extends through the connecting portion 6 according to FIG. 1(a) in the pipe longitudinal direction.

By inclining the protrusions 28 and 30 and by joining the protrusions 28 and 30 on the longitudinal edges 24 and 26 with the corresponding recesses 12 on the respective opposite longitudinal edges 26 and 24, a closed pipe connecting portion 6 is obtained, in which the protrusions 28 and 30 each engage positively in the respective corresponding recesses 12, and in which the flanks of the protrusions 28, 30 and of the recesses 12 each have a sequence and direction of extension of the pairs of protrusion flank and abutting recess flank, as shown in FIG. 4(a), below. This is achieved by the inclined positioning of the protrusions 28 and 30 and by bending them into the plane, in particular the tangential plane, of the connecting portion 6 during joining. This is enhanced by the formation of the protrusions 28, 30 with oversize with respect to the respective corresponding recesses 12.

As can be seen in FIG. 4(a), below, along the sectional plane A-A of the connecting portion 6, at positions where protrusions 28 with a first oblique direction of extension have been bent into the plane of the connecting portion 6, respective pairs 32 of protrusion flank and abutting recess flank with a first oblique direction of extension have been created. At positions where protrusions 30 with a second oblique direction of extension have been bent into the plane of the connecting portion 6, respective pairs 34 of protrusion flank and abutting recess flank with an opposite second oblique direction of extension have been created.

The first oblique direction of extension runs obliquely to the right, as seen from the inside to the outside of the pipe, i.e. in the direction of the pipe end on the right in FIG. 4(a).

The opposite second oblique direction of extension runs obliquely to the left, as seen from the inside to the outside of the pipe, i.e. in the direction of the pipe end on the left in FIG. 4(a).

Along the connecting portion 6, this results in a sequence of four pairs 32 each consisting of a protrusion flank and an abutting recess flank, each having a first oblique direction of extension, followed by four pairs 34 each consisting of a protrusion flank and an abutting recess flank, each having an opposite second oblique direction of extension.

When the pattern is viewed in terms of shape or form in the sectional plane A-A, there results a sequence of three parallelogram-shaped protrusions 36 each with a direction of extension obliquely outwards to the right, i.e. in the direction of the right-hand end of the pipe, of a trapezoidal protrusion 38 with a wider inner side, of three parallelogram-shaped protrusions 36 each with a direction of extension obliquely outwards to the left, i.e. in the direction of the left-hand end of the pipe, of a trapezoidal protrusion 38 with a wider outer side, and so on.

This pattern results from a sequence of two protrusions each with a first oblique direction of extension 28 and two protrusions each with a second oblique direction of extension 30 in the underlying metallic flat material 22.

According to FIG. 5(a), protrusions 28 with a first oblique direction of extension and protrusions 30 with a second oblique direction of extension are alternately arranged along the first longitudinal edge 24 of the metallic flat material 22. When joining them to form a closed connecting portion 6 by bending the protrusions 28 and 30 into the plane of the connecting portion 6, the resulting sequence of the pairs of protrusion flank and abutting recess flank is as shown in FIG. 5(a), namely with two flank pairs 32 each with first oblique direction of extension, two flank pairs 34 each with opposite second oblique direction of extension, again two flank pairs 32 with first oblique direction of extension, and so on.

When the pattern is viewed in terms of shape or design in the sectional plane A-A, the following sequence results: a parallelogram-shaped protrusion 36 with an oblique direction of extension outwards in the direction of the right-hand pipe end, a trapezoidal protrusion 38 with a wider inner side, a parallelogram-shaped protrusion 36 with an oblique direction of extension outwards in the direction of the left-hand pipe end 18, a trapezoidal protrusion 38 with a wide outer side. This sequence in terms of shape or design is repeated as long as the closed connecting portion 6 is formed from an alternating sequence of protrusions 28 with a first oblique direction of extension and protrusions 30 with a second oblique direction of extension.

The pattern of protrusions 28, 30 along the first longitudinal edge 24 and of the flank pairs 32, 34 and the sequence of parallelogram-shaped protrusions 36 and of the trapezoidal protrusions 38 shown in FIG. 5(b) corresponds to the pattern shown with reference to FIG. 4(a).

There are provided along the first longitudinal edge 24 alternately two protrusions 28 each with a first oblique direction of extension and two protrusions 30 each with a second oblique direction of extension 30. This results in a flank pair course along the closed connecting portion 6 in the pipe longitudinal direction 8 as follows: alternately four flank pairs 32 each with a first direction of extension and four flank pairs 34 each with an opposite second oblique direction of extension. In terms of shape or design, the following sequence is present: three parallelogram-shaped protrusions 36 with a first oblique direction of extension in the radial direction of the pipe obliquely outwards towards the right-hand pipe end (of which the middle parallelogram-shaped protrusion 36 has a smaller width than the two parallelogram-shaped protrusions 36 enclosing it), a trapezoidal protrusion 38 with a wider inner side, three parallelogram-shaped protrusions 36 with a second opposite oblique direction of extension in the radial direction of the pipe outwards towards the left-hand pipe end (of which the middle parallelogram-shaped protrusion 36 has a smaller width than the two parallelogram-shaped protrusions 36 enclosing it), then a trapezoidal protrusion 38 with a wider outer side. This pattern is repeated as long as it is created from a sequence of two protrusions 28 each with a first oblique direction of extension and two protrusions 30 each with a second oblique direction of extension along the first longitudinal edge 24.

The width of the protrusions 36 and 38 depends on the position of the sectional plane in the width direction through the connecting portion 6 or through the longitudinal edges 24, 26. If the cutting plane is displaced in the width direction within the connecting portion 6, the width of the protrusions 36 and 38 also changes. The protrusions 10 and the recesses 12 can have a puzzle-piece-like shape (see FIG. 1), possibly with an intermediate collar 50 (see FIG. 1), or a dovetail-like shape (see FIG. 2).

In the illustration according to FIG. 6(a), the protrusions 40, as seen in a front view of the first longitudinal edge 24, each have substantially the shape of a U and the protrusions 42, as seen in a front view of the second longitudinal edge 26, each have substantially the shape of an inverted U. In each case, a central portion of the respective protrusion 40, 42 is arranged in the plane of the main body of the metallic flat material 22 and the outer portions of the protrusions 40, 42, as seen in the longitudinal direction along the first and second longitudinal edges 24, 26, respectively, are both bent upwards (protrusions 40) and both bent downwards (protrusions 42), respectively, as seen in a front view of the longitudinal edges 24, 26.

When the longitudinal edges 24, 26 are joined together to form a closed connecting portion 6, so that the protrusions 40 on the first longitudinal edge 24 positively engage in respective opposite recesses 12 and the protrusions 42 on the second longitudinal edge 26 positively engage in respective opposite recesses 12 of the first longitudinal edge 24, and when the protrusions 40, 42 or their outer sections are bent into the plane of the connecting portion 6, a course of flank pairs is produced along the connecting portion 6, as shown in FIG. 6(a), below. In each case, flank pairs 32 consisting of protrusion flank and recess flank with a first oblique direction of extension obliquely outwards towards the right-hand pipe end alternate with flank pairs 34 consisting of protrusion flank and recess flank with a second opposite oblique direction of extension obliquely outwards towards the left-hand pipe end.

In terms of shape or design, trapezoidal protrusions 38 with a wider outer side alternate with trapezoidal protrusions 38 with a wider inner side.

Also in FIG. 6(b), the protrusions are arranged alternately along the first and second longitudinal edges 24, 26, with the protrusions 44 on the first longitudinal edge 24 of the metallic flat material 22 here having the shape of a V and the protrusions 46 on the second longitudinal edge 26 each having the shape of an inverted V. Again, a middle portion of these protrusions 44, 46 is integrally connected to the main body of the metallic flat material 22 and lies in the plane thereof. The two outer portions of the protrusions 44, 46, as seen in the longitudinal direction of the edges, extend upwardly (protrusions 44) and downwardly (protrusions 46) from the plane of the metallic flat material 22.

When the longitudinal edges 24, 26 are joined together to form a closed connecting portion 6, so that the protrusions 44 on the first longitudinal edge 24 engage in corresponding recesses 12 on the second longitudinal edge 26 and protrusions 46 on the second longitudinal edge 26 engage in corresponding recesses 12 on the first longitudinal edge 24, and when the protrusions 44, 46, in particular the outer portions of the protrusions 44, 46, are bent into the plane of the connecting portion 6, the pattern or flank pair progression results as shown in FIG. 6(b) below.

This pattern corresponds to the corresponding pattern in FIG. 6(a) and will not be explained again here to avoid repetitions.

FIG. 7 shows a metallic flat material 48 with a first longitudinal edge 24 and with a second longitudinal edge 26 and with protrusions 10 and recesses 12 arranged alternately on both longitudinal edges 24, 46.

The metallic flat material 48 substantially corresponds to the metallic flat material 22 shown in FIG. 1(b), with the differences described below. Identical elements are marked with the same reference numerals and will not be explained again here.

The first longitudinal edge 24 again has a pattern of protrusions 10 and recesses 12 therebetween. Similarly, the second longitudinal edge 26 has a pattern of protrusions 10 and recesses 12 therebetween.

Both the protrusions 10 and the recesses 12 have a rounded, substantially puzzle-piece-like shape, with a head portion 16 of greater width and with a neck portion 14 of smaller width, wherein here an outwardly projecting intermediate collar 50 is formed in addition in the neck portion 14 of smaller width, which subdivides the neck portion 14 into a first neck portion region on the bottom side and a second neck portion region on the head side.

As can be clearly seen in FIG. 7, when viewed in the longitudinal direction along the first and second longitudinal edges 24, 26 respectively, the position of the protrusions 10 on the first longitudinal edge 24 corresponds in each case to the position of the recesses 12 on the second longitudinal edge 26, and similarly the position of the recesses 12 on the first longitudinal edge 24 corresponds in each case to the position of the protrusions 10 on the second longitudinal edge 26.

The shape of the protrusions 10 and the recesses 12 on the first longitudinal edge 24 in each case also corresponds to the shape of the recesses 12 and the protrusions 10 on the second longitudinal edge 26.

As can be clearly seen in FIG. 7, the head portions 16 on the first longitudinal edge 24 are slightly wider than the head portions 16 on the second longitudinal edge 26, and the width of the recesses 12 on the first longitudinal edge 24 is slightly smaller than the width of the recesses 12 on the second longitudinal edge 26.

The course and shape of the side flanks of the neck portions 14 on the first longitudinal edge 24 correspond in each case substantially to the course and shape of the side flanks of the neck portions 14 on the second longitudinal edge 26.

The neck portions 14 of the first lateral edge 24 located externally adjacent to the respective transverse side of the metallic flat material 48 are formed with less depth and without intermediate collars. Similarly, the protrusions located externally adjacent to the respective transverse side of the metallic flat material 48 are formed with less depth and without intermediate collars 50, so that their shape and design correspond to each other and they can respectively engage with each other.

The width of the protrusions 10 on the first longitudinal edge 24 in each case is slightly oversized with respect to the width of the corresponding recesses 12 on the second longitudinal edge 26, in particular with an oversize of 0.05-1.0 mm, as seen in the longitudinal direction of the respective longitudinal edge 24, 26, i.e. in the top-bottom direction of the drawing plane in FIG. 7. The same applies to the width of the protrusions 10 on the second longitudinal edge 26, which are also formed with an oversize of in particular 0.05-1.0 mm compared to the corresponding recesses 12 on the first longitudinal edge 24.

For producing a thin-walled pipe from this metallic flat material 48, reference is made to the description of FIG. 1. This will not be repeated here.

It is easy to imagine how a thin-walled pipe can be produced from the metallic flat material 48, for example by rolling or bending, in which the metallic flat material 48 forms the jacket of the pipe and in which connecting elements 10, 12 are connected to one another on the longitudinal edges 24, 26 by positive interlocking or interengagement along a connecting portion extending in the pipe longitudinal direction. A section along a sectional plane, analogous to the sectional plane A-A according to FIG. 4(b), which extends through the connecting portion in the pipe longitudinal direction, results in a sectional view as shown in FIG. 4, 5 or 6. The specific sectional view depends on the design of the connecting elements 10, 12, in particular the protrusions 10, with respect to the plane of the main body of the metallic flat material 48.

The protrusions and recesses of the exemplary embodiments described above and shown in FIGS. 1-7 can also be combined, in particular in an alternating sequence along the connecting portion extending in the pipe longitudinal direction.

For example, the puzzle-piece-shaped protrusions 10 and recesses 12 of FIG. 1, 4 or 5 can be combined with the U-shaped or inverted U-shaped protrusions 40, 42 of FIG. 6(a) or with the V-shaped or inverted V-shaped protrusions 44, 46 of FIG. 6(b).

Furthermore, the dovetail-like protrusions 10 and recesses 12 of FIG. 2 can be combined with the U-shaped or inverted U-shaped protrusions 40, 42 of FIG. 6(a) or with the V-shaped or inverted V-shaped protrusions 44, 46 of FIG. 6(b).

It is also possible to combine the U-shaped or inverted U-shaped protrusions 40, 42 of FIG. 6(a) with the V-shaped or inverted V-shaped protrusions 44, 46 of FIG. 6(b).

All of these combinations are covered by the present application.

The advantages and technical effects indicated in the general description part apply to the thin-walled pipe, to the metallic flat material and to the manufacturing method, which have been described here with reference to the exemplary embodiments in FIGS. 1 to 7. To avoid repetitions, these will not be listed again.

### LIST OF REFERENCE NUMERALS

2 pipe
4 jacket
6 connecting portion
8 pipe longitudinal direction
10 protrusions
12 recesses
14 neck portion
16 head portion
17 end face portion
18 first pipe end
20 second pipe end
22 metallic flat material
24 first longitudinal edge
26 second longitudinal edge
28 protrusions with first oblique direction of extension
30 protrusions with second oblique direction of extension
32 flank pair with first direction of extension
34 flank pair with second direction of extension
36 parallelogram-shaped protrusions
38 trapezoidal protrusions
A-A sectional plane
40 protrusions with U-shape
42 protrusions with inverted U-shape
44 protrusions with V-shape
46 protrusions with inverted V-shape
48 metallic flat material
50 intermediate collar

1. A thin-walled pipe (2), comprising:
a thin metallic flat material (22) rolled or bent into a pipe (2), having longitudinal edges (24, 26) connected to one another by positive interengagement of connecting elements along a connecting portion (6) extending in a longitudinal direction (8) of the thin-walled pipe (2);
wherein the thin-walled pipe (2) has a first axial pipe end (18) and a second axial pipe end (20);
wherein the connecting elements are protrusions (10) on a first longitudinal edge (24) of the thin metallic flat material (22) and corresponding recesses (12) on a second longitudinal edge (26) of the thin metallic flat material (22); and
wherein at least one protrusion (10) engages in a corresponding recess (12) so that flanks of the at least one protrusion (10) abut at least partially against respective adjacent flanks of the corresponding recess (12) in the pipe-longitudinal direction (8);
characterized in that
the thin metallic flat material (22) has a wall thickness of 0.05-1.00 mm;
at least one pair (32, 34) of a protrusion flank and of an abutting recess flank, as seen in an axial sectional plane (A-A) extending along the connecting portion (6), in each case has an inclined course from a pipe outer wall to a pipe inner wall, and in each case encloses an angle of 15-75°, including 30-60°, with a radial plane of the thin-walled pipe (2);
at least one pair (32) of a protrusion flank and of an abutting recess flank, as seen in a sectional plane along the connecting portion (6), in each case has an inclined course with a first oblique direction of extension from the pipe outer wall to the pipe inner wall in the direction of one of the pipe ends (20);
at least one pair (34) of a protrusion flank and of an abutting recess flank, as seen in a sectional plane along the connecting portion (6), in each case has an inclined course with an opposite second oblique direction of extension from the pipe outer wall to the pipe inner wall in the direction of the other pipe end (18); and
pairs (32) of a protrusion flank and of an abutting recess flank with a first oblique direction of extension, as seen along the connecting portion (6), are arranged alternately with pairs (34) of a protrusion flank and of an abutting recess flank with an opposite second oblique direction of extension, so that the protrusions (28, 30) and recesses (12), as seen in a sectional plane (A-A) along the connecting portion (6), in particular alternately have substantially the shape of a parallelogram (36) and substantially the shape of a trapezoid (38).

2-3. (canceled)

4. The thin-walled pipe (2) according to claim 1,
wherein the sequence of the pairs (32, 34) of a protrusion flank and of an abutting recess flank, as seen along the connecting portion (6), is at least in portions as follows:
alternately two pairs (32) each with a first oblique direction of extension, and two, four or six pairs (34) each with an opposite second oblique direction of extension; or
alternately four pairs (32) each with a first oblique direction of extension, and two, four or six pairs (34) each with an opposite second oblique direction of extension;
alternately six pairs (32) each with a first oblique direction of extension, and two, four or six pairs (34) each with an opposite second oblique direction of extension.

5. The thin-walled pipe (2) according to claim 1,
wherein at least one protrusion (10) engages in a corresponding recess (12) in such a way that the end face (17) of the protrusion (10) at least partially abuts against the end face (17) of the corresponding recess (12); and/or
wherein the end faces (17) lie substantially in an axial plane extending along the connecting portion (6).

6. The thin-walled pipe (2) according to claim 1,
wherein a bead, a material accumulation portion or a material thickening portion is formed in the abutting area of at least one pair (32, 34) of a protrusion flank and of a recess flank abutting thereon.

7. The thin-walled pipe (2) according to claim 1,
wherein at least one protrusion (10) and/or at least one recess (12) has a tapered neck portion (14) and a widened head portion (16); and/or
wherein at least one protrusion (10) and/or at least one recess (12) has a tapered neck portion (14) and a widened head portion (16), with an intermediate collar (50) in the neck portion, which subdivides the neck portion (14) into a head-side recess portion and a bottom-side recess portion; and/or
wherein at least one protrusion (10) and/or at least one recess (12), as seen in plan view, has the shape of a rounded puzzle piece protrusion or a rounded puzzle piece recess, or the shape of a dovetail.

8. A metallic flat material (22) for producing the thin-walled pipe (2) according to claim 1 by rolling or bending, comprising:
a first longitudinal edge (24) and an opposite second longitudinal edge (26),
wherein at least one connecting element in the form of a protrusion (10) is arranged on the first longitudinal edge (24) and at least one corresponding connecting element in the form of a recess (12) is arranged on the second longitudinal edge (26) in a corresponding longitudinal position;
wherein the connecting element formed as a protrusion (10) is bent with respect to the plane of the main body of the metallic flat material (22); and
wherein the protrusion (28, 30) has a straight course as seen in a front view of the first longitudinal edge (24) and encloses an angle with the plane of the main body of the metallic flat material (22);
wherein the protrusion (10) is formed with an oversize relative to the corresponding recess (12);
wherein the length of the protrusion (10) substantially corresponds to the length of the recess (12);
wherein at least one protrusion (28) has a first direction of extension and at least one protrusion (30) having a second direction of extension;
wherein the at least one protrusion (28) has a relative gradient from the first flat material end to the second flat material end as seen in a front view of the first longitudinal edge (24); and
wherein the at least one protrusion (30) has a corresponding relative gradient from the second flat material end to the first flat material end as seen in a front view of the first longitudinal edge (24);
characterized in that
the flat metallic material (22) has a wall thickness of 0.05-0.10 mm; and
the width of the protrusion (10) is greater than the width of the corresponding recess (12) by an oversize of 0.05-1.0 mm for enhancing the formation of a respective inclined course of protrusion flank to the respective abutting recess flank.

9-10. (canceled)

11. The metallic flat material (22) according to claim 8,
wherein the sequence of the protrusions (28) with a first direction of extension and of the protrusions (30) with a second direction of extension, as seen along the longitudinal edge (24, 26), is at least in portions as follows:
alternately one protrusion (28) each with a first direction of extension and one to five protrusions (30) each with a second direction of extension;
alternately two protrusions (28) each with a first direction of extension and one to five protrusions (30) each with a second direction of extension;
alternately three protrusions (28) each with a first direction of extension and one to five protrusions (30) each with a second direction of extension.

12. The metallic flat material (22, 48) according to claim 11,
wherein at least one protrusion (10) and/or at least one recess (12) has a tapered neck portion (14) and a widened head portion (16); and/or
wherein at least one protrusion (10) and/or at least one recess (12) has a tapered neck portion (14) and a widened head portion (16), with an intermediate collar (50) in the neck portion, which subdivides the neck portion (14) into a head-side recess portion and a bottom-side recess portion; and/or
wherein at least one protrusion (10) and/or at least one recess (12), as seen in plan view, has the shape of a rounded puzzle piece protrusion or a rounded puzzle piece recess, or the shape of a dovetail.

13. A method for producing a thin-walled pipe (2) according to claim 1, comprising the following steps:
providing a metallic flat material (22) according to any of claims 8 to 12;
rolling or bending the metallic flat material (22) into a thin-walled pipe (2), using a mandrel or center piece and a block or counterpart pressing against the same from the outside; and
joining the longitudinal edges (24, 26) together such
that the connecting elements positively engage with each other along a connecting portion (6) extending in the pipe longitudinal direction (8); and
that the at least one connecting element formed as a protrusion (10), which is bent at least partially with respect to the plane of the main body of the metallic flat material (22), is bent into the plane of the connecting portion (6) such that the pair made up of the protrusion flank of this protrusion (10) and of the abutting recess flank, as seen in an axial sectional plane (A-A) extending along the connecting portion (6), in each case has an inclined course from pipe outer wall to pipe inner wall and/or encloses an angle of 15-75°, in particular 30-60°, with the pipe radial plane;
wherein the width of the protrusion (10) is greater than the width of the corresponding recess (10) by an oversize of 0.05-1.0 mm, which enhances the formation of a respective inclined course of protrusion flank to the respective abutting recess flank;
wherein a pair (32) of a protrusion flank and of an abutting recess flank, as seen in a sectional plane along the connecting portion (6), in each case has an inclined course with a first oblique direction of extension from the pipe outer wall to the pipe inner wall in the direction of one of the pipe ends (20);
wherein a pair (34) of a protrusion flank and of an abutting recess flank, as seen in a sectional plane along the connecting portion (6), in each case has an inclined course with an opposite second oblique direction of extension from the pipe outer wall to the pipe inner wall in the direction of the other pipe end (18); and
wherein pairs (32) of a protrusion flank and of an abutting recess flank with a first oblique direction of extension, as seen along the connecting portion (6), are arranged alternately with pairs (34) of a protrusion flank and of an abutting recess flank with an opposite second oblique direction of extension, so that the protrusions (28, 30) and recesses (12), as seen in a sectional plane (A-A) along the connecting portion (6), in particular alternately have substantially the shape of a parallelogram (36) and substantially the shape of a trapezoid (38).

14. The thin-walled pipe (2) according to claim 4,
wherein at least one protrusion (10) engages in a corresponding recess (12) in such a way that the end face (17) of the protrusion (10) at least partially abuts against the end face (17) of the corresponding recess (12); and/or
wherein the end faces (17) lie substantially in an axial plane extending along the connecting portion (6).

15. The thin-walled pipe (2) according to claim 4,
wherein a bead, a material accumulation portion or a material thickening portion is formed in the abutting area of at least one pair (32, 34) of a protrusion flank and of a recess flank abutting thereon.

16. The thin-walled pipe (2) according to claim 4,
wherein at least one protrusion (10) and/or at least one recess (12) has a tapered neck portion (14) and a widened head portion (16); and/or
wherein at least one protrusion (10) and/or at least one recess (12) has a tapered neck portion (14) and a widened head portion (16), with an intermediate collar (50) in the neck portion, which subdivides the neck portion (14) into a head-side recess portion and a bottom-side recess portion; and/or
wherein at least one protrusion (10) and/or at least one recess (12), as seen in plan view, has the shape of a rounded puzzle piece protrusion or a rounded puzzle piece recess, or the shape of a dovetail.

17. The thin-walled pipe (2) according to claim 5,
wherein a bead, a material accumulation portion or a material thickening portion is formed in the abutting area of at least one pair (32, 34) of a protrusion flank and of a recess flank abutting thereon.

18. The thin-walled pipe (2) according to claim 5,
wherein at least one protrusion (10) and/or at least one recess (12) has a tapered neck portion (14) and a widened head portion (16); and/or
wherein at least one protrusion (10) and/or at least one recess (12) has a tapered neck portion (14) and a widened head portion (16), with an intermediate collar (50) in the neck portion, which subdivides the neck portion (14) into a head-side recess portion and a bottom-side recess portion; and/or
wherein at least one protrusion (10) and/or at least one recess (12), as seen in plan view, has the shape of a rounded puzzle piece protrusion or a rounded puzzle piece recess, or the shape of a dovetail.

19. The thin-walled pipe (2) according to claim 6,
wherein at least one protrusion (10) and/or at least one recess (12) has a tapered neck portion (14) and a widened head portion (16); and/or
wherein at least one protrusion (10) and/or at least one recess (12) has a tapered neck portion (14) and a widened head portion (16), with an intermediate collar (50) in the neck portion, which subdivides the neck portion (14) into a head-side recess portion and a bottom-side recess portion; and/or
wherein at least one protrusion (10) and/or at least one recess (12), as seen in plan view, has the shape of a rounded puzzle piece protrusion or a rounded puzzle piece recess, or the shape of a dovetail.
